(19) United States
(12) Patent Application Publication
(10) Pub. No.: US 2024/0380702 A1
(43) Pub. Date: Nov. 14, 2024

(54) SYSTEMS AND METHODS FOR IDENTIFYING PACKETS BASED ON PACKET DETECTION RULES

(71) Applicant: Verizon Patent and Licensing Inc., Basking Ridge, NJ (US)

(72) Inventors: Ravi POTLURI, Coppell, TX (US); Sudhakar Reddy PATIL, Flower Mound, TX (US); Kalyani BOGINENI, Irving, TX (US)

(73) Assignee: Verizon Patent and Licensing Inc., Basking Ridge, NJ (US)

(21) Appl. No.: 18/316,707

(22) Filed: May 12, 2023

(51) Int. Cl. H04L 47/2483; H04L 12/14; H04W 28/02; H04W 28/06

(52) U.S. Cl. CPC H04L 47/2483; H04L 12/1407; H04W 28/0236; H04W 28/065

(57) ABSTRACT

In some implementations, an entity in a wireless network may receive a packet with a flag set to a first value, wherein the first value indicates that the packet is associated with non-low latency, low loss and scalable throughput (non-L4S) traffic. The entity may determine, based on a packet detection rule, that the packet should be associated with L4S traffic. The entity may transmit, based on a determination that the packet should be associated with L4S traffic, the packet with the flag set to a second value, wherein the second value indicates that the packet is associated with L4S traffic.

### BACKGROUND

Wireless communication systems are widely deployed to provide various telecommunication services such as telephony, video, data, messaging, and broadcasts. A wireless network may include one or more network nodes that support communication for wireless communication devices, such as a user equipment (UE). A UE may communicate with a network node via downlink communications and uplink communications. “Downlink” (or “DL”) refers to a communication link from the network node to the UE, and “uplink” (or “UL”) refers to a communication link from the UE to the network node.

### BRIEF DESCRIPTION OF THE DRAWINGS

FIG. 1 is a diagram of an example of a low-latency, low-loss scalable-throughput services (L4S) negotiation and congestion response.

FIG. 2 is a diagram of an example of a network flow with L4S.

FIG. 3 is a diagram of an example of an L4S negotiation and congestion response with an Internet Protocol (IP) header bleaching.

FIG. 4 is a diagram of an example of a network flow with L4S and IP header bleaching.

FIG. 5 is a diagram of an example associated with setting flags associated with packets based on packet detection rules.

FIG. 6 is a diagram of an example environment in which systems and/or methods described herein may be implemented.

FIG. 7 is a diagram of example components of one or more devices of FIG. 6.

FIG. 8 is a flowchart of an example process associated with setting flags associated with packets based on packet detection rules.

### DETAILED DESCRIPTION OF EXAMPLE EMBODIMENTS

The following detailed description of example implementations refers to the accompanying drawings. The same reference numbers in different drawings may identify the same or similar elements.

Low-latency, low-loss scalable-throughput services (L4S) may serve to reduce latency in a wireless network. L4S may be aimed to address queue delay problems by relying on explicit congestion notifications (ECNs). A packet may be marked with an ECN to indicate congestion in the wireless network. The ECN may be a congestion marking for the packet. The ECN may indicate that the packet should avoid being dropped due to the congestion. A network node may receive the packet that is marked with the ECN. The network node may be expected to respond to the congestion marking by adapting its transmission rate. The network node, when transmitting the packet marked with the ECN, may adapt its transmission rate (e.g., reduce the transmission rate) to reduce a likelihood of the packet being buffered and/or dropped by the wireless network. L4S may be applicable to extended reality (XR) services provided in the wireless network, which may include augmented reality (AR), virtual reality (VR), and/or mixed reality (MR).

In an L4S architecture, L4S traffic may be isolated from non-L4S traffic (e.g., typical traffic). L4S traffic may encounter less buffering, as compared to non-L4S traffic (e.g., due to lower transmission rates associated with L4S traffic), which may result in less latency for L4S traffic as compared to non-L4S traffic. In the L4S architecture, appropriate congestion signaling may be provided for both L4S traffic and non-L4S traffic. The L4S architecture may support protocol features that allow network nodes to identify L4S traffic and allow for the communication of congestion signaling. A host (e.g., an application) may support a congestion signaling with an appropriate congestion response that enables scalable performance.

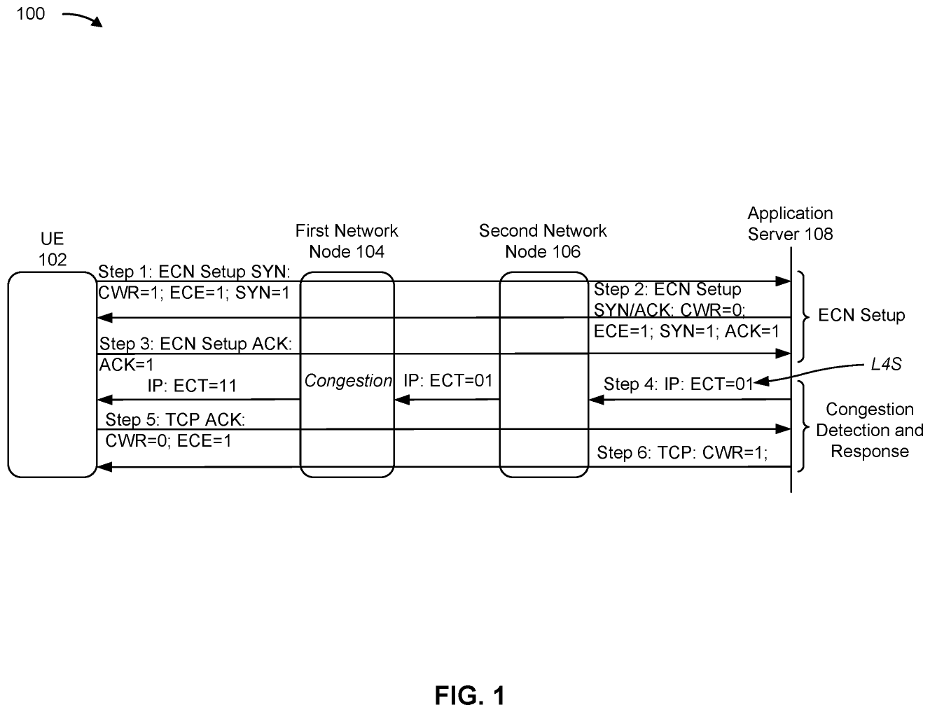

FIG. 1 is a diagram of an example 100 of an L4S negotiation and congestion response. In a first step, as part of an ECN setup, a user equipment (UE) 102 may transmit an ECN setup synchronize sequence number (SYN) message. The ECN setup SYN message may indicate a congestion window reduced (CWR) value (e.g., CWR=1), an explicit congestion notification echo (ECE) value (e.g., ECE=1), and a SYN value (e.g., SYN=1). The UE may transmit the ECN setup SYN message to an application server 108 via one or more intermediate nodes (e.g., a first network node 104 and a second network node 106). In a second step, as part of the ECN setup, the application server 108 may transmit an ECN setup SYN acknowledgement (ACK) (SYN/ACK) message. The ECN setup SYN/ACK message may indicate a CWR value (e.g., CWR=0), an ECE value (e.g., ECE=1), a SYN value (e.g., SYN=1), and an ACK value (e.g., ACK=1). The application server 108 may transmit the ECN SYN/ACK message via the one or more intermediate nodes. In a third step, as part of the ECN setup, the UE 102 may transmit an ECN setup ACK message. The ECN setup ACK message may indicate an ACK value (e.g., ACK=1). An ECN/L4S may be negotiated end-to-end in a transmission control protocol (TCP) (e.g., a transport layer) based on the ECN setup SYN message, the ECN SYN/ACK message, and the ECN setup ACK message.

In a fourth step, as part of a congestion detection and response, the application server 108 may transmit L4S traffic to the UE 102. The application server 108 may transmit an Internet Protocol (IP) packet. The IP packet may indicate an ECN-capable transport (ECT) value (e.g., ECT=01), such as an ECT flag. An IP packet header may carry an L4S marking (e.g., ECT=01) when a negotiation is successful. The L4S marking may be an L4S-compliance marking. The ECT value (e.g., ECT=01) may be an indication of L4S traffic, such that L4S traffic may be handled differently from non-L4S traffic. For example, network nodes may ensure that traffic marked with the ECT value (e.g., ECT=01) receives prioritized treatment in terms of buffering. The second network node 106 may receive the IP packet with the ECT value. The second network node 106 may forward the IP packet with the ECT value (e.g., ECT=01) to the first network node 104. The second network node 106 may not change the ECT value associated with the IP packet. The first network node 104 may be associated with a congestion. The first network node 104 may update the ECT value to indicate a congestion marking (e.g., ECT=11), and the first network node 104 may transmit the IP packet with the updated ECT value (e.g., ECT=11) to the UE 102.

The first network node 104 may be able to indicate the congestion marking based on the IP packet already being associated with the ECT value (e.g., ECT=01) (which indicates that the IP packet is associated with L4S traffic). When the IP packet is associated with another ECT value (e.g., ECT=00) (which indicates that the IP packet is not associated with L4S traffic), the first network node 104 may not be able to indicate the congestion marking for the IP packet.

In a fifth step, as part of the congestion detection and response, the UE 102 may transmit a TCP ACK message. The TCP ACK message may indicate a CWR value (e.g., CWR=0) and an ECE value (e.g., ECE=1). A congestion marking may be echoed back by the UE 102 in transport acknowledgements, and a reduced transmission rate by the application server 108 may be enabled based on the congestion marking. In a sixth step, as part of the congestion detection and response, the application server 108 may transmit a TCP message. The TCP message may indicate a CWR value (e.g., CWR=1).

As indicated above, FIG. 1 is provided as an example. Other examples may differ from what is described with regard to FIG. 1.

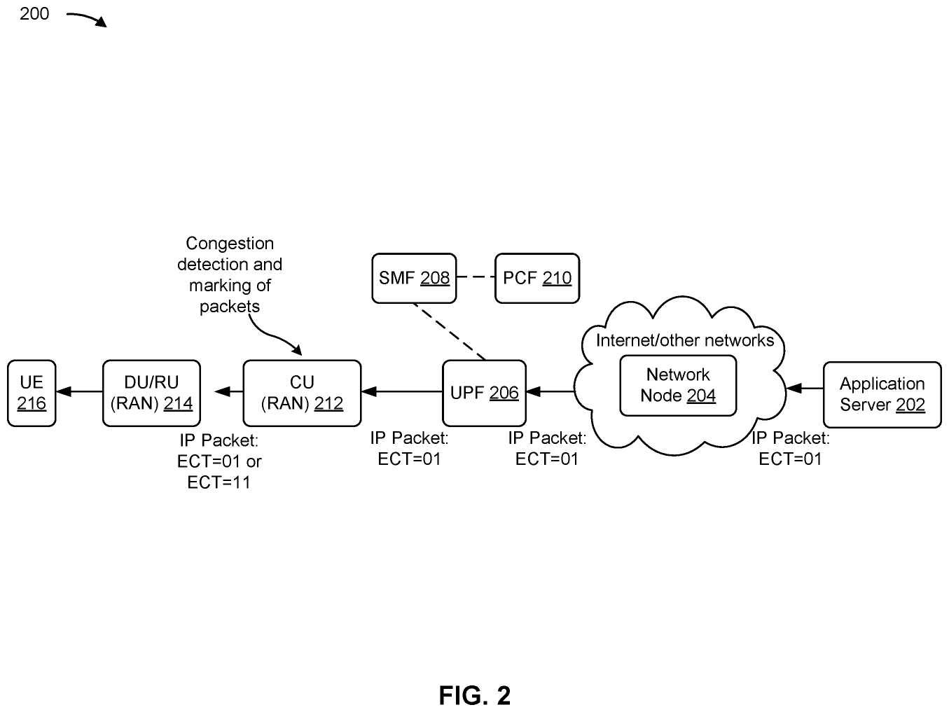

FIG. 2 is a diagram of an example 200 of a network flow with L4S. As shown in FIG. 2, an application server 202 may transmit an IP packet to a network node 204. The IP packet may indicate an ECT value (e.g., ECT=01), which may indicate an L4S-compliance marking. The ECT value (e.g., ECT=01) may be an indication of L4S traffic. The network node 204 may forward the IP packet with the ECT value (e.g., ECT=01) to a user plane function (UPF) 206, which may be associated with a session management function (SMF) 208 and a policy control function (PCF) 210. The UPF 206 may forward the IP packet with the ECT value (e.g., ECT=01) to a centralized unit (CU) 212. The CU 212 may be responsible for a congestion detection and for a congestion marking for the IP packet. When no congestion is detected, the CU 212 may keep the same ECT value (e.g., ECT=01). When congestion is detected, the CU 212 may update the ECT value (e.g., ECT=11). The CU 212 may forward the IP packet with the ECT value (e.g., ECT=01 when no congestion is detected or ECT=11 when congestion is detected) to a distributed unit (DU) and/or a radio unit (RU) (DU/RU) 214. The CU 212 and the DU/RU 214 may be associated with a radio access network (RAN). The DU/RU 214 may forward the IP packet to a UE 216. The UE 216 may echo back a congestion marking based on the ECT value associated with the IP packet.

As indicated above, FIG. 2 is provided as an example. Other examples may differ from what is described with regard to FIG. 2.

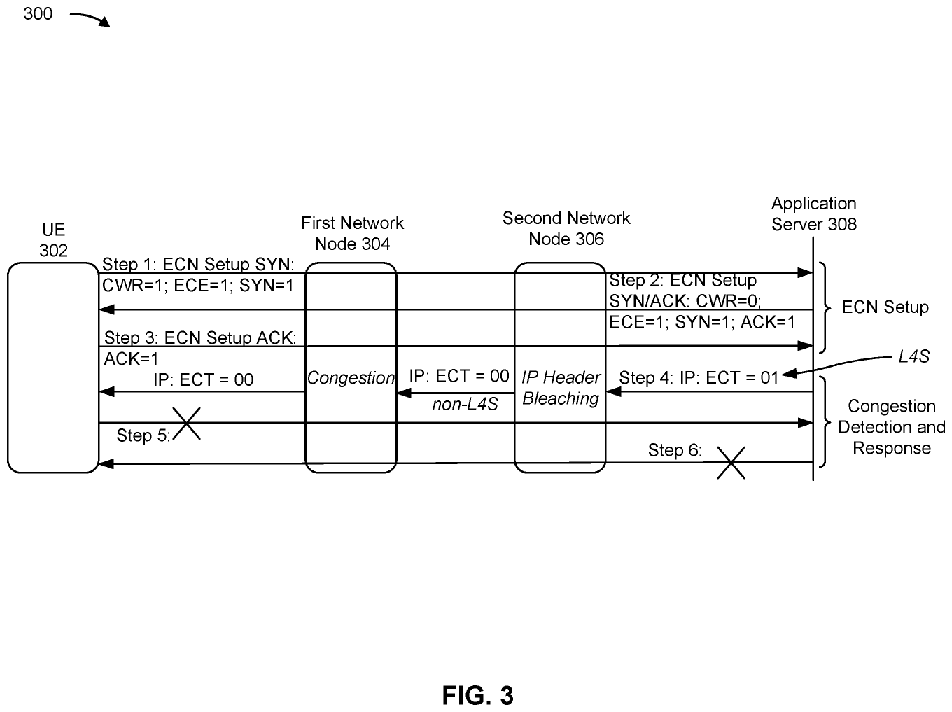

FIG. 3 is a diagram of an example 300 of an L4S negotiation and congestion response with an IP header bleaching. In a first step, a second step, and a third step, an ECN setup may be established between a UE 302 and an application server 308 via one or more intermediate nodes (e.g., a first network node 304 and a second network node 306), similar to as described above with respect to FIG. 1.

In a fourth step, as part of a congestion detection and response, the application server 308 may transmit L4S traffic to the UE 302. The application server 308 may transmit an IP packet. The IP packet may indicate an ECT value (e.g., ECT=01), such as an ECT flag. An IP packet header may carry an L4S marking (e.g., ECT=01) when a negotiation is successful. The L4S marking may be an L4S-compliance marking. The ECT value (e.g., ECT=01) may be an indication of L4S traffic, such that L4S traffic may be handled differently from non-L4S traffic. The second network node 306 may receive the IP packet with the ECT value. However, the second network node 306 may be associated with an IP header bleaching, which may cause the second network node 306 to remove or reset the ECT value associated with the IP packet. For example, due to the IP header bleaching, the second network node 306 may change the ECT value (e.g., from ECT=01 to ECT=00), such that the IP packet may appear to be associated with non-L4S traffic. In other words, based on the changed ECT value (e.g., ECT=00) due to the IP header bleaching, the IP packet may appear to be associated with non-L4S traffic. The second network node 306 may forward the IP packet with the changed ECT value (e.g., ECT=00) to the first network node 304. The first network node 304 may be associated with a congestion. However, since the IP packet may be associated with the changed ECT value, which may be indicative of non-L4S traffic, the first network node 304 may be unable to update the ECT value to indicate a congestion marking. For example, the first network node 304 may be unable to update the ECT value to 11 to indicate the congestion, which may cause the first network node 304 to transmit the IP packet with the same changed ECT value (e.g., ECT=00) to the UE 302. The first network node 304 may not be able to indicate the congestion marking based on the IP packet being associated with the changed ECT value (e.g., ECT=00) due to the IP header bleaching (which indicates that the IP packet is not associated with L4S traffic). An intermediate node, such as the second network node 306, may remove the L4S-compliance marking, which may impact a downstream network node (e.g., the first network node 304) recognizing the IP packet as L4S-compliant, and a congestion message may not be transmitted to the UE 302.

In a fifth step, as part of the congestion detection and response, the UE 302 may be unable to transmit a TCP ACK message. A congestion marking may not be echoed back by the UE 302 in transport acknowledgements, and a reduced transmission rate by the application server 308 may not be enabled due to the lack of congestion marking. In a sixth step, as part of the congestion detection and response, the application server 308 may not transmit a TCP message. In other words, the UE 302 may not receive the congestion message, and the UE 302 may not notify the application server 308 of the congestion message.

As indicated above, FIG. 3 is provided as an example. Other examples may differ from what is described with regard to FIG. 3.

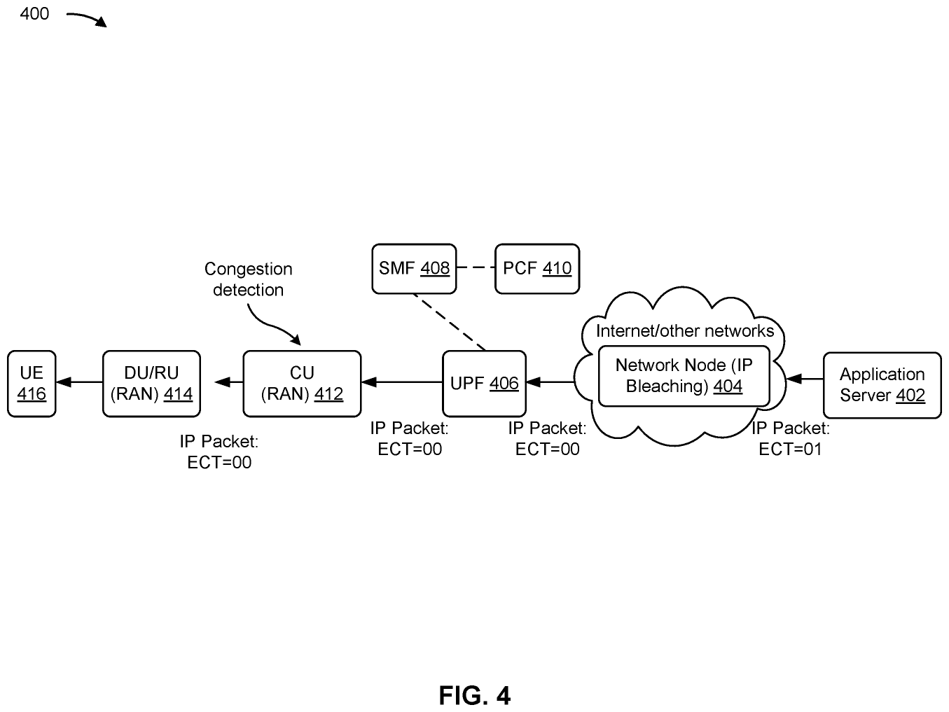

FIG. 4 is a diagram of an example 400 associated with a network flow with L4S and IP header bleaching. As shown in FIG. 4, an application server 402 may transmit an IP packet to a network node 404. The IP packet may indicate an ECT value (e.g., ECT=01), which may indicate an L4S-compliance marking. The ECT value (e.g., ECT=01) may be an indication of L4S traffic. The network node 404 may be associated with an IP header bleaching, which may cause the network node 404 to remove or reset the ECT value associated with the IP packet. For example, due to the IP header bleaching, the network node 404 may change the ECT value (e.g., from ECT=01 to ECT=00), such that the IP packet may appear to be associated with non-L4S traffic. In other words, based on the changed ECT value (e.g., ECT=00) due to the IP header bleaching, the IP packet may appear to be associated with non-L4S traffic.

The network node 404 may forward the IP packet with the changed ECT value (e.g., ECT=00) to a UPF 406, which may be associated with an SMF 408 and a PCF 410. The UPF 406 may forward the IP packet with the changed ECT value (e.g., ECT=00) to a CU 412. The CU 412 may be responsible for a congestion detection and for a congestion marking for the IP packet. However, regardless of whether congestion is detected, the CU 412 may be unable to change the ECT value to indicate congestion (e.g., ECT=11) due to the IP header bleaching. The CU 412 may forward the IP packet with the changed ECT value (e.g., ECT=00) to a DU/RU 414. The DU/RU 414 may forward the IP packet to a UE 416. The UE 416 may be unable to echo back a congestion marking due to the IP header bleaching, and a network adaptation (e.g., a lower transmission rate) may not be performed due to the IP header bleaching.

As indicated above, FIG. 4 is provided as an example. Other examples may differ from what is described with regard to FIG. 4.

A congestion signaling for L4S may depend on a network node, which may be able to mark congestion, detecting that traffic received by the network node is L4S-compliant. The network node may detect that the traffic is L4S-compliant based on an IP header flag (e.g., ECT=10) associated with the traffic. An L4S-compliance in an IP header of the traffic may need to reach the network node (e.g., the congestion-marking node) intactly from a transmitting server (e.g., an application server). However, some networks as well as cloud providers may bleach ECN/L4S flags in IP headers to cause the traffic to appear as non-L4S-compliant traffic. When the ECN/L4S flags in the IP headers are bleached, the ECN/L4S flags may be removed or reset to a value (e.g., ECT=00) that is associated with non-L4S-compliant traffic. An IP header bleaching may impede an operator's ability to offer an L4S service. For example, for traffic that is actually L4S traffic but has been bleached to appear as non-L4S traffic, the network node may be unable to mark the traffic with a congestion indicator. As a result, the traffic may not receive prioritized treatment in terms of buffering, and the traffic may be more likely to be dropped during transmission, thereby degrading an overall network performance.

In some implementations, an entity in a wireless network, such as a UPF, may receive an IP packet from an application server via a network node. The IP packet may be associated with a flag set to a first ECT value, where the first ECT value may indicate that the IP packet is associated with non-L4S traffic. However, the entity may check whether the IP packet is actually associated with non-L4S traffic, or whether the IP packet should actually be associated with L4S traffic. In some cases, the IP packet may appear to be associated with non-L4S traffic due to an IP header bleaching, where in fact the IP packet is actually associated with L4S traffic. The entity may apply packet detection rules to determine whether the flag for the IP packet is set correctly. The entity may be provisioned with the packet detection rules by another entity in the wireless network or by a combination of entities, such as an SMF and a PCF. When the entity determines, using the packet detection rules, that the IP packet should actually be associated with L4S traffic, the entity may set the flag associated with the packet to a second ECT value. The second ECT value may indicate that the IP packet is associated with L4S traffic. The entity may transmit the IP packet with the flag set to the second ECT value to a downstream network node.

In some implementations, the entity may restore the IP header flag for L4S compliance when the entity detects that the IP packet should be L4S compliant, which may mitigate the IP header bleaching performed by the network node (e.g., an upstream network node). By the IP header flag being restored, traffic may be treated as L4S traffic, which may allow certain policies (e.g., reduced transmission rate) to be applied to the traffic during a presence of network congestion. When the IP header flag is not restored, the traffic may be treated as non-L4S traffic, even when the traffic is L4S traffic, which may prevent such policies from being applied.

In some implementations, by the IP header flag for L4S compliance being restored, a capability for L4S marking may be restored, and thus an ability to support an L4S service, even when other networks are non-compliant. A configurability of a control of an L4S marking restoration may be achieved through a wireless policy framework. Further, the L4S marking restoration may be supported at a flow or session level through policy rules.

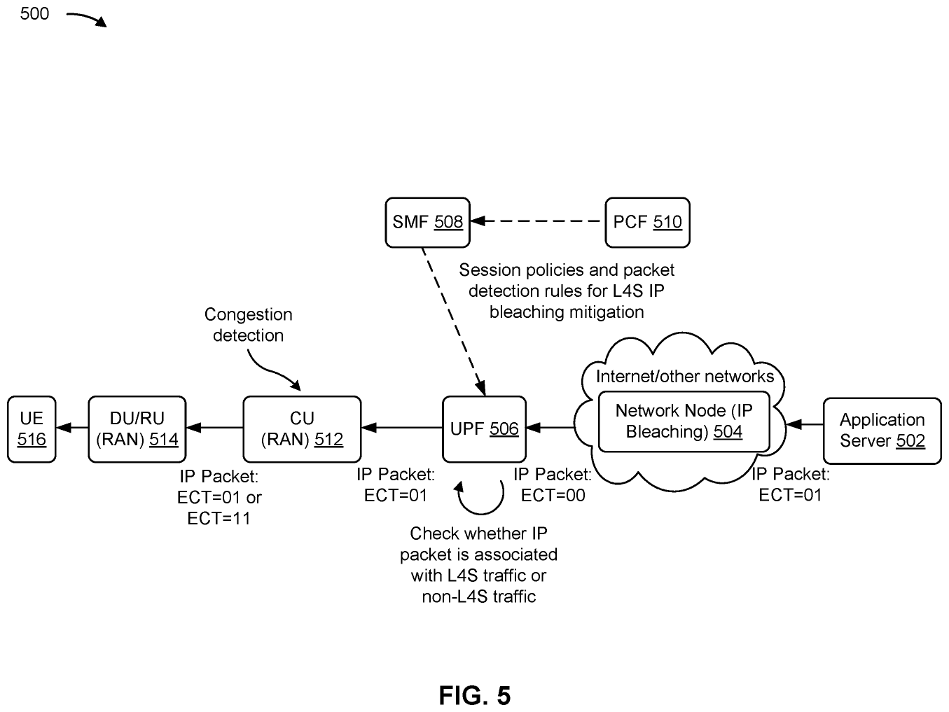

FIG. 5 is a diagram of an example 500 associated with setting flags associated with packets based on packet detection rules. As shown in FIG. 5, example 500 includes an application server 502, a network node 504, a UPF 506, an SMF 508, a PCF 510, a CU 512, a DU/RU 514, and a UE 516. The CU 512 and the DU/RU 514 may be associated with a RAN. The network node 504 may be associated with an IP header bleaching.

In some implementations, the UPF 506 may receive, from the PCF 510 and via the SMF 508, session policies and packet detection rules for L4S IP packet bleaching mitigation. The UPF 506 may receive, from the PCF 510 and via the SMF 508, policy and charging control (PCC) rules provisioned for a session. The PCC rules may include an L4S control data configuration that indicates the packet detection rules. As an example, the PCF may transmit the L4S control data configuration (L4SControlData) within the PCC rules provisioned for the session, as part of a session management policy decision (SMPolicyDecision) response to the SMF, when a new session is being created. The SMF may provision the PCC rules with the L4S control data configuration in the UPF. The L4S control data configuration may indicate a plurality of L4S control identifiers (14scld) (e.g., unique identifiers) for a plurality of network nodes, respectively, and for each network node, status information. The status information, for a certain network node, may indicate that L4S for that network node is enabled, disabled, enabled in only a downlink direction, or enabled in only an uplink direction. The PCC rules may include, in addition to existing data elements, a reference L4S control data (refl4scData) parameter, which may include an array of references to the L4S control data configuration. The UPF may use the packet detection rules to restore flags (e.g., ECT bits or ECN/L4S bits) associated with received IP packets, based on the L4S control data configuration in the PCC rules.

In some implementations, the application server 502 may transmit an IP packet. The IP packet may be associated with downlink traffic. The IP packet may be associated with a second ECT value (e.g., ECT=01). The IP packet may include a flag set to the second ECT value. The second ECT value may indicate that the IP packet is associated with L4S traffic (e.g., L4S-compliant traffic). The network node 504 may receive the IP packet from the application server 502. The network node 504 may be associated with an Internet network or another network. The network node 504 may bleach an IP header of the IP packet, which may cause the flag associated with the IP packet to be removed or reset. For example, when the IP packet is subjected to an IP header bleaching, the second ECT value may be incorrectly changed to a first ECT value (e.g., ECT=00). The first ECT value may indicate that the IP packet is associated with non-L4S traffic (e.g., non-L4S-compliant traffic), even though the IP packet may actually be associated with L4S traffic. The network node 504 may transmit the IP packet with the first ECT value to the UPF 506.

In some implementations, the UPF 506 may receive the IP packet with the first ECT value (e.g., ECT=00) from the network node 504. The UPF 506 may check, using the packet detection rules, whether the IP packet should be associated with the first ECT value or the second ECT value, even though the IP packet may appear to be associated with the first ECT value. In some cases, the UPF 506 may check each IP packet having the first ECT value received from the network node 504, or alternatively, the UPF 506 may check a subset of IP packets having the first ECT value. The UPF 506 may determine, based on the packet detection rules, whether the IP packet is actually associated with non-L4S traffic, or whether the IP packet is actually associated with L4S traffic.

In some implementations, the UPF 506 may determine, based on the packet detection rules, that the IP packet should be associated with L4S traffic. In some implementations, the UPF 506 may determine that the IP packet should be associated with L4S traffic based on a 5-tuple associated with the IP packet. The 5-tuple may include a source IP address, a source port, a destination IP address, a destination port, and/or a protocol associated with the IP packet. The UPF 506 may use the 5-tuple to identify known servers and/or clients that use L4S services. The UPF 506 may access the L4S control data configuration in the PCC rules, as received from the PCF 510 via the SMF 508. The UPF 506 may determine, from the L4S control data configuration, that the source IP address, the source port, the destination IP address, and/or the destination port associated with the IP packet are associated with L4S services. The UPF 506 may determine that the IP packet should be associated with L4S traffic, even though the flag associated with the IP packet is set to the first ECT value indicating non-L4S traffic. The UPF 506 may use the packet detection rules to detect traffic that should have been marked as L4S compliant.

In some implementations, the UPF 506 may determine that the IP packet should be associated with L4S traffic based on ongoing traffic flows that are associated with L4S traffic. The UPF 506 may detect ongoing traffic flows between the application server 502 to the UE 516. When some of the ongoing traffic flows are associated with L4S traffic, the UPF 506 may assume that other ongoing traffic flows are also associated with L4S traffic, even when the flag associated with the IP packet is set to the first ECT value indicating non-L4S traffic. For the ongoing traffic flows, when some of the ongoing traffic flows are already L4S-compliant, the UPF 506 may recognize IP header bleaching on an upstream path associated with the IP packet that is set to the first ECT value indicating non-L4S traffic.

In some implementations, the UPF 506 may restore the flag associated with the IP packet. The UPF 506 may restore the flag in the IP header associated with the IP packet, where the IP packet may be associated with downlink traffic. The UPF 506 may set the flag to the second ECT value, instead of the first ECT value. The UPF 506 may reset the flag to the second ECT value (e.g., ECT=01), which was originally associated with the IP packet when the IP packet was transmitted from the application server 502. The UPF 506 may transmit the IP packet with the flag set to the second ECT value, which may indicate that the IP packet is associated with L4S traffic.

In some implementations, the CU 512 may receive, from the UPF 506, the IP packet with the flag set to the second ECT value (e.g., ECT=01). The CU 512 may be responsible for a congestion detection and for a congestion marking for the IP packet. When no congestion is detected by the CU 512, the CU 512 may keep the second ECT value (e.g., ECT=01) for the IP packet. In other words, when no congestion is detected, the CU 512 may keep the same second ECT value. When congestion is detected by the CU 512, the CU 512 may replace the second ECT value with a third ECT value (e.g., ECT=11). The third ECT value may be associated with a network congestion. The CU 512 may transmit the IP packet with the flag set to the second ECT value or the third ECT value, and the IP packet may be received by the DU/RU 514. The DU/RU 514 may transmit the IP packet with the flag set to the second ECT value or the third ECT value, and the IP packet may be received by the UE 516. In some cases, the UE 516 may echo back a congestion marking based on the third ECT value associated with the IP packet, and the application server 502 may adapt a transmission rate (e.g., reduce the transmission rate), which may reduce a likelihood of downlink IP packets being buffered and/or dropped.

In some implementations, to mitigate against IP header bleaching that occurs in a downstream network node, the UPF 506 may be configured to check whether a received IP packet is associated with L4S traffic or non-L4S traffic, even when the flag associated with the IP packet indicates that the IP packet is associated with non-L4S traffic. In other words, the UPF 506 may be aware that the IP packet may incorrectly be labeled as non-L4S traffic, which may be due to the IP header bleaching. The UPF 506 may apply the packet detection rules, which may be provisioned by the SMF 508 and/or the PCF 510, to check whether the flag associated with the IP packet should be restored to indicate that the IP packet is indeed associated with L4S traffic. As a result, when congestion is present in a downstream network node, the IP packet may be able to be marked with a congestion marker (e.g., ECT=11). When the IP packet is marked with the congestion marker, the IP packet may be handled in a prioritized manner in terms of buffering to improve latency and reliability. Otherwise, when the IP packet is not able to be marked with the congestion marker (e.g., due to the IP header bleaching), the IP packet may not receive prioritized treatment and may subsequently be dropped. By configuring the UPF 506 with the packet detection rules, and by configuring the UPF 506 to check flags associated with IP packets for incorrect non-L4S markings, an overall network performance may be improved.

As indicated above, FIG. 5 is provided as an example. Other examples may differ from what is described with regard to FIG. 5. The number and arrangement of devices shown in FIG. 5 are provided as an example. In practice, there may be additional devices, fewer devices, different devices, or differently arranged devices than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) shown in FIG. 5 may perform one or more functions described as being performed by another set of devices shown in FIG. 5.

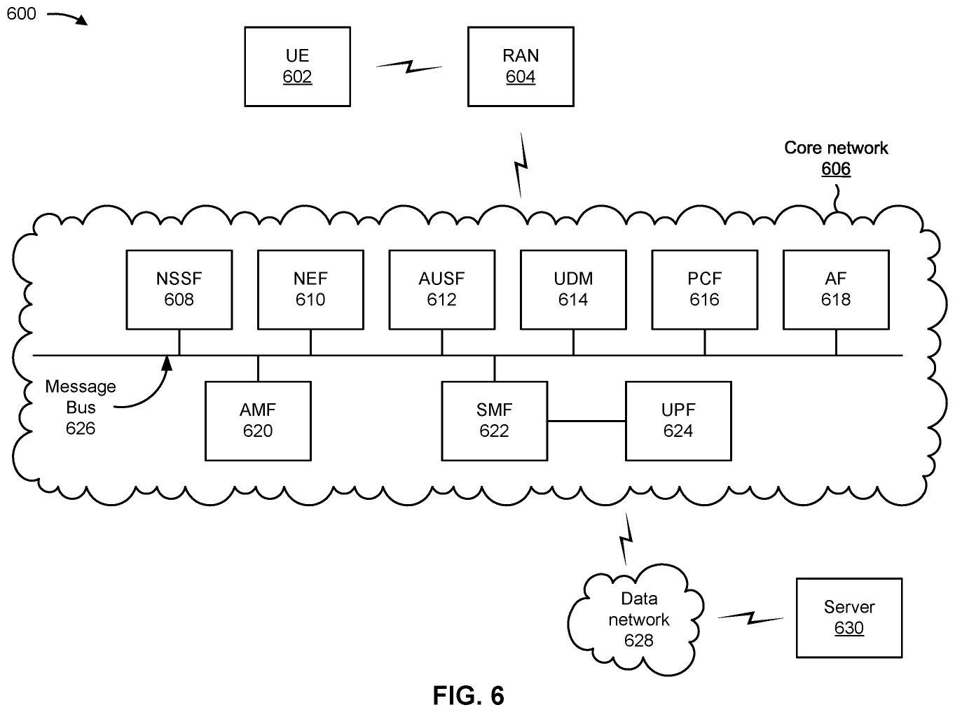

FIG. 6 is a diagram of an example environment 600 in which systems and/or methods described herein may be implemented. As shown in FIG. 6, example environment 600 may include a UE 602, a RAN 604, a core network 606, a data network 628, and a server 630. Devices and/or networks of example environment 600 may interconnect via wired connections, wireless connections, or a combination of wired and wireless connections.

The UE 602 may include one or more devices capable of receiving, generating, storing, processing, and/or providing information, such as information described herein. For example, the UE 602 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The RAN 604 may support, for example, a cellular radio access technology (RAT). The RAN 604 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 102. The RAN 604 may transfer traffic between the UE 602 (e.g., using a cellular RAT), one or more base stations (e.g., using a wireless interface or a backhaul interface, such as a wired backhaul interface), and/or the core network 606. The RAN 604 may provide one or more cells that cover geographic areas. The RAN 604 may include a disaggregated base station, meaning that a base station is configured to utilize a protocol stack that is physically or logically distributed among two or more nodes (such as one or more central units (CUs), one or more distributed units (DUs), or one or more radio units (RUs)).

In some implementations, the RAN 604 may perform scheduling and/or resource management for the UE 602 covered by the RAN 604 (e.g., the UE 602 covered by a cell provided by the RAN 604). In some implementations, the RAN 604 may be controlled or coordinated by a network controller, which may perform load balancing, network-level configuration, and/or other operations. The network controller may communicate with the RAN 604 via a wireless or wireline backhaul. In some implementations, the RAN 604 may include a network controller, a self-organizing network (SON) module or component, or a similar module or component. In other words, the RAN 604 may perform network control, scheduling, and/or network management functions (e.g., for uplink, downlink, and/or sidelink communications of the UE 602 covered by the RAN 604).

In some implementations, the core network 606 may include an example functional architecture in which systems and/or methods described herein may be implemented. For example, the core network 606 may include an example architecture of a fifth generation (5G) next generation (NG) core network included in a 5G wireless telecommunications system. The core network 606 may include a number of functional elements. The functional elements may include, for example, a network slice selection function (NSSF) 608, a network exposure function (NEF) 610, an authentication server function (AUSF) 612, a unified data management (UDM) component 614, a PCF 616, an application function (AF) 618, an access and mobility management function (AMF) 620, an SMF 622, and/or a UPF 624. These functional elements may be communicatively connected via a message bus 626. The functional elements may be implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 608 may include one or more devices that select network slice instances for the UE 602. By providing network slicing, the NSSF 608 may allow an operator to deploy multiple substantially independent end-to-end networks potentially with the same infrastructure. In some implementations, each slice may be customized for different services. The NEF 610 may include one or more devices that support exposure of capabilities and/or events in the wireless telecommunications system to help other entities in the wireless telecommunications system discover network services. The AUSF 612 may include one or more devices that act as an authentication server and support the process of authenticating the UE 602 in the wireless telecommunications system. The UDM 614 may include one or more devices that store user data and profiles in the wireless telecommunications system. The UDM 614 may be used for fixed access and/or mobile access in the core network 606. The PCF 616 may include one or more devices that provide a policy framework that incorporates network slicing, roaming, packet processing, and/or mobility management, among other examples. The AF 618 may include one or more devices that support application influence on traffic routing, access to the NEF 610, and/or policy control, among other examples. The AMF 620 may include one or more devices that act as a termination point for non-access stratum (NAS) signaling and/or mobility management, among other examples.

The SMF 622 may include one or more devices that support the establishment, modification, and release of communication sessions in the wireless telecommunications system. For example, the SMF 622 may configure traffic steering policies at the UPF 624 and/or may enforce user equipment IP address allocation and policies, among other examples. The UPF 624 may include one or more devices that serve as an anchor point for intra-RAT and/or inter-RAT mobility. The UPF 624 may apply rules to packets, such as rules pertaining to packet routing, traffic reporting, and/or handling user plane QoS, among other examples. The message bus 626 may represent a communication structure for communication among the functional elements. In other words, the message bus 626 may permit communication between two or more functional elements.

The data network 628 may include one or more wired and/or wireless data networks. For example, the data network 628 may include an IP Multimedia Subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The server 630 may include one or more devices capable of receiving, generating, storing, processing, providing, and/or routing information, such as information described herein. The server 630 may include a communication device and/or a computing device. For example, the server 630 may include an application server, a client server, a web server, a database server, a host server, a proxy server, a virtual server (e.g., executing on computing hardware), or a server in a cloud computing system. In some implementations, the server 630 may include computing hardware used in a cloud computing environment.

The number and arrangement of devices and networks shown in FIG. 6 are provided as an example. In practice, there may be additional devices and/or networks, fewer devices and/or networks, different devices and/or networks, or differently arranged devices and/or networks than those shown in FIG. 6. Furthermore, two or more devices shown in FIG. 6 may be implemented within a single device, or a single device shown in FIG. 6 may be implemented as multiple, distributed devices. Additionally, or alternatively, a set of devices (e.g., one or more devices) of example environment 600 may perform one or more functions described as being performed by another set of devices of example environment 600.

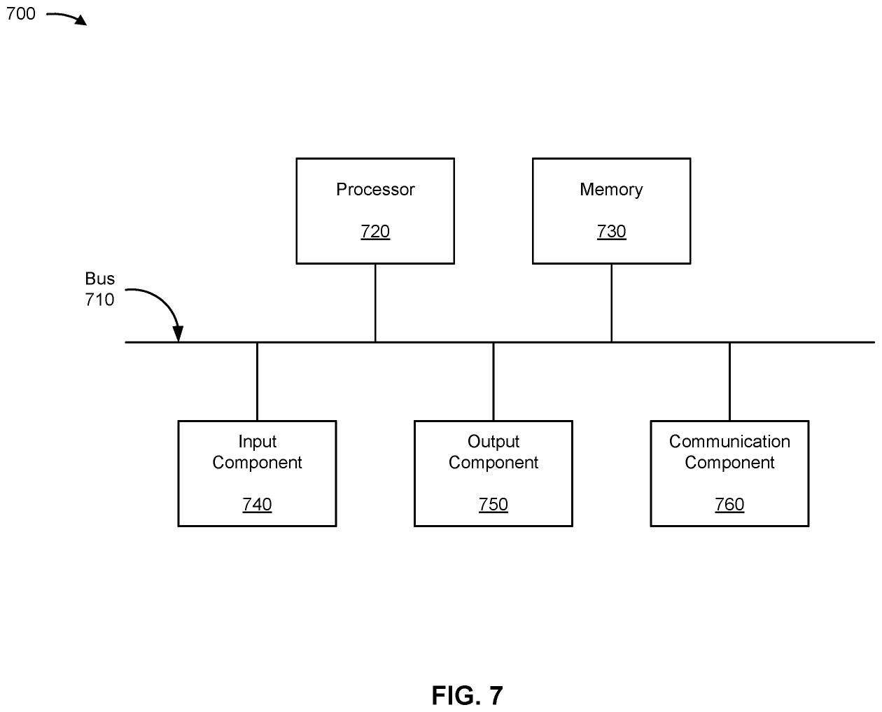

FIG. 7 is a diagram of example components of a device 700 associated with setting flags associated with packets based on packet detection rules. The device 700 may correspond to PCF 616, SMF 622, and/or UPF 624. In some implementations, PCF 616, SMF 622, and/or UPF 624 may include one or more devices 700 and/or one or more components of the device 700. As shown in FIG. 7, the device 700 may include a bus 710, a processor 720, a memory 730, an input component 740, an output component 750, and/or a communication component 760.

The bus 710 may include one or more components that enable wired and/or wireless communication among the components of the device 700. The bus 710 may couple together two or more components of FIG. 7, such as via operative coupling, communicative coupling, electronic coupling, and/or electric coupling. For example, the bus 710 may include an electrical connection (e.g., a wire, a trace, and/or a lead) and/or a wireless bus. The processor 720 may include a central processing unit, a graphics processing unit, a microprocessor, a controller, a microcontroller, a digital signal processor, a field-programmable gate array, an application-specific integrated circuit, and/or another type of processing component. The processor 720 may be implemented in hardware, firmware, or a combination of hardware and software. In some implementations, the processor 720 may include one or more processors capable of being programmed to perform one or more operations or processes described elsewhere herein.

The memory 730 may include volatile and/or nonvolatile memory. For example, the memory 730 may include random access memory (RAM), read only memory (ROM), a hard disk drive, and/or another type of memory (e.g., a flash memory, a magnetic memory, and/or an optical memory). The memory 730 may include internal memory (e.g., RAM, ROM, or a hard disk drive) and/or removable memory (e.g., removable via a universal serial bus connection). The memory 730 may be a non-transitory computer-readable medium. The memory 730 may store information, one or more instructions, and/or software (e.g., one or more software applications) related to the operation of the device 700. In some implementations, the memory 730 may include one or more memories that are coupled (e.g., communicatively coupled) to one or more processors (e.g., processor 720), such as via the bus 710. Communicative coupling between a processor 720 and a memory 730 may enable the processor 720 to read and/or process information stored in the memory 730 and/or to store information in the memory 730.

The input component 740 may enable the device 700 to receive input, such as user input and/or sensed input. For example, the input component 740 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 750 may enable the device 700 to provide output, such as via a display, a speaker, and/or a light-emitting diode. The communication component 760 may enable the device 700 to communicate with other devices via a wired connection and/or a wireless connection. For example, the communication component 760 may include a receiver, a transmitter, a transceiver, a modem, a network interface card, and/or an antenna.

The device 700 may perform one or more operations or processes described herein. For example, a non-transitory computer-readable medium (e.g., memory 730) may store a set of instructions (e.g., one or more instructions or code) for execution by the processor 720. The processor 720 may execute the set of instructions to perform one or more operations or processes described herein. In some implementations, execution of the set of instructions, by one or more processors 720, causes the one or more processors 720 and/or the device 700 to perform one or more operations or processes described herein. In some implementations, hardwired circuitry may be used instead of or in combination with the instructions to perform one or more operations or processes described herein. Additionally, or alternatively, the processor 720 may be configured to perform one or more operations or processes described herein. Thus, implementations described herein are not limited to any specific combination of hardware circuitry and software.

The number and arrangement of components shown in FIG. 7 are provided as an example. The device 700 may include additional components, fewer components, different components, or differently arranged components than those shown in FIG. 7. Additionally, or alternatively, a set of components (e.g., one or more components) of the device 700 may perform one or more functions described as being performed by another set of components of the device 700.

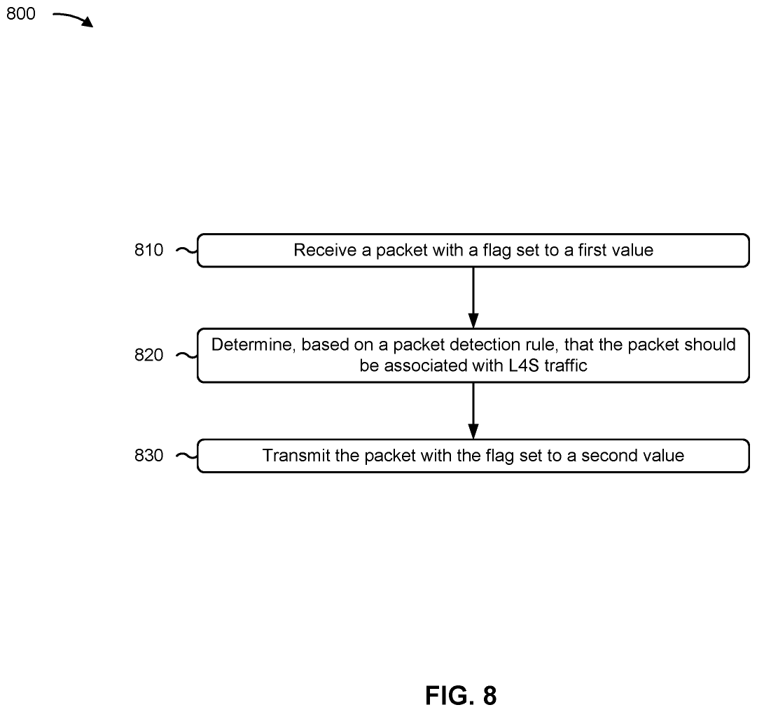

FIG. 8 is a flowchart of an example process 800 associated with setting flags associated with packets based on packet detection rules. In some implementations, one or more process blocks of FIG. 8 may be performed by a UPF (e.g., UPF 624). In some implementations, one or more process blocks of FIG. 8 may be performed by another device or a group of devices separate from or including the UPF, such as a PCF (e.g., PCF 616) and/or an SMF (e.g., SMF 622). Additionally, or alternatively, one or more process blocks of FIG. 8 may be performed by one or more components of device 700, such as processor 720, memory 730, input component 740, output component 750, and/or communication component 760.

As shown in FIG. 8, process 800 may include receiving a packet with a flag set to a first value, wherein the first value indicates that the packet is associated with non-L4S traffic (block 810). The packet may be an IP packet. The first value may be an ECT value. For example, the first value may be set to “00” when the packet is associated with non-L4S traffic. The packet may be received from a network node associated with a packet header bleaching (e.g., an IP header bleaching), which may cause a header of the packet to be incorrectly marked as being associated with non-L4S traffic.

As further shown in FIG. 8, process 800 may include determining, based on a packet detection rule, that the packet should be associated with L4S traffic (block 820). PCC rules may include an L4S control data configuration that indicates the packet detection rule. The PCC rules may be provisioned for a session associated with the packet. The packet may be determined to be associated with L4S traffic based on a 5-tuple associated with the packet. The 5-tuple may include a source IP address, a source port, a destination IP address, a destination port, and/or a protocol associated with the packet. The packet may be determined to be associated with L4S traffic based on ongoing traffic flows that are associated with L4S traffic. The packet may be determined to be associated with L4S traffic, based on the packet detection rule, even though the first value may indicate that the packet is associated with non-L4S traffic.

As further shown in FIG. 8, process 800 may include transmitting, based on determining that the packet should be associated with L4S traffic, the packet with the flag set to a second value, wherein the second value indicates that the packet is associated with L4S traffic (block 830). The second value may be an ECT value. For example, the second value may be set to “01” when the packet is associated with L4S traffic. In some cases, the flag of the packet may be enabled to be subsequently set to a third value (e.g., an ECT value of 11) based on a network congestion, based on the flag being set to the second value instead of the first value. The flag of the packet may be set to a third value by a downstream node in a RAN. By setting the flag to the third value, the packet may be handled in a prioritized manner to improve reliability and reduce latency.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by an entity in a wireless network, a packet with a flag set to a first value, wherein the first value indicates that the packet is associated with non-low latency, low loss and scalable throughput (non-L4S) traffic;
determining, by the entity and based on a packet detection rule, that the packet should be associated with L4S traffic; and
transmitting, by the entity and based on determining that the packet should be associated with L4S traffic, the packet with the flag set to a second value, wherein the second value indicates that the packet is associated with L4S traffic.

2. The method of claim 1, wherein determining, based on the packet detection rule, that the packet should be associated with L4S traffic is based on a data associated with the packet, wherein the data includes one or more of a source IP address, a source port, a destination IP address, a destination port, or a protocol associated with the packet.

3. The method of claim 1, wherein determining, based on the packet detection rule, that the packet should be associated with L4S traffic is based on ongoing traffic flows that are associated with L4S traffic.

4. The method of claim 1, further comprising:
receiving, from a policy control function (PCF) via a session management function (SMF), policy and charging control (PCC) rules provisioned for a session, wherein the PCC rules include an L4S control data configuration that indicates the packet detection rule.

5. The method of claim 1, wherein the packet is received from a network node associated with a packet header bleaching, and a header of the packet is incorrectly marked as being associated with non-L4S traffic based on the packet header bleaching.

6. The method of claim 1, wherein the flag of the packet is enabled to be set to a third value based on a network congestion, based on the flag being set to the second value instead of the first value.

7. The method of claim 1, wherein the packet is an Internet Protocol (IP) packet, the packet is associated with downlink traffic, and the first value and the second value are explicit congestion notification (ECN)-capable transport (ECT) values.

8. The method of claim 1, wherein the entity is a user plane function (UPF).

9. A device, comprising:
one or more processors configured to:
receive a packet with a flag set to a first value, wherein the first value indicates that the packet is associated with non-low latency, low loss and scalable throughput (non-L4S) traffic;
determine, based on a packet detection rule, that the packet should be associated with L4S traffic; and
transmit, based on a determination that the packet should be associated with L4S traffic, the packet with the flag set to a second value, wherein the second value indicates that the packet is associated with L4S traffic.

10. The device of claim 9, wherein the one or more processors are configured to determine, based on the packet detection rule, that the packet should be associated with L4S traffic based on a 5-tuple associated with the packet, wherein the 5-tuple includes one or more of a source IP address, a source port, a destination IP address, a destination port, or a protocol associated with the packet.

11. The device of claim 9, wherein the one or more processors are configured to determine, based on the packet detection rule, that the packet should be associated with L4S traffic based on ongoing traffic flows that are associated with L4S traffic.

12. The device of claim 9, wherein the one or more processors are further configured to:
receive, from a policy control function (PCF) via a session management function (SMF), policy and charging control (PCC) rules provisioned for a session, wherein the PCC rules include an L4S control data configuration that indicates the packet detection rule.

13. The device of claim 9, wherein the packet is received from a network node associated with a packet header bleaching, and a header of the packet is incorrectly marked as being associated with non-L4S traffic based on the packet header bleaching.

14. The device of claim 9, wherein the flag of the packet is enabled to be set to a third value based on a network congestion, based on the flag being set to the second value instead of the first value.

15. The device of claim 9, wherein the packet is an Internet Protocol (IP) packet, the packet is associated with downlink traffic, and the first value and the second value are explicit congestion notification (ECN)-capable transport (ECT) values.

16. A non-transitory computer-readable medium storing a set of instructions, the set of instructions comprising:
one or more instructions that, when executed by one or more processors of a device, cause the device to:
receive a packet with a flag set to a first value, wherein the first value indicates that the packet is associated with non-low latency, low loss and scalable throughput (non-L4S) traffic;
determine, based on a packet detection rule, that the packet should be associated with L4S traffic; and
transmit, based on a determination that the packet should be associated with L4S traffic, the packet with the flag set to a second value, wherein the second value indicates that the packet is associated with L4S traffic.

17. The non-transitory computer-readable medium of claim 16, wherein the one or more instructions, when executed by the one or more processors, cause the device to:
determine, based on the packet detection rule, that the packet should be associated with L4S traffic based on a 5-tuple associated with the packet, wherein the 5-tuple includes one or more of a source IP address, a source port, a destination IP address, a destination port, or a protocol associated with the packet; or
determine, based on the packet detection rule, that the packet should be associated with L4S traffic based on ongoing traffic flows that are associated with L4S traffic.

18. The non-transitory computer-readable medium of claim 16, wherein the one or more instructions, when executed by the one or more processors, further cause the device to:
receive, from a policy control function (PCF) via a session management function (SMF), policy and charging control (PCC) rules provisioned for a session, wherein the PCC rules include an L4S control data configuration that indicates the packet detection rule.

19. The non-transitory computer-readable medium of claim 16, wherein the packet is received from a network node associated with a packet header bleaching, and a header of the packet is incorrectly marked as being associated with non-L4S traffic based on the packet header bleaching.

20. The non-transitory computer-readable medium of claim 16, wherein the packet is an Internet Protocol (IP) packet, the packet is associated with downlink traffic, and the first value and the second value are explicit congestion notification (ECN)-capable transport (ECT) values.
